(19) United States
(12) Patent Application Publication
(10) Pub. No.: US 2014/0151002 A1
(43) Pub. Date: Jun. 5, 2014

(54) SHIELDING PLATE HAVING A COOLANT LINE

(71) Applicants: Tobias Vogler, Herzogenaurach (DE); Raphael Fischer, Herzogenaurach (DE)

(72) Inventors: Tobias Vogler, Herzogenaurach (DE); Raphael Fischer, Herzogenaurach (DE)

(73) Assignee: Schaeffler Technologies AG & Co. KG, Herzogenaurach (DE)

(21) Appl. No.: 14/236,256

(22) PCT Filed: Jul. 31, 2012
(86) PCT No.: PCT/EP2012/064917

§ 371 Date: Jan. 30, 2014

(30) Foreign Application Priority Data
Aug. 24, 2011 (DE) DE102011081507.4

(51) Int. Cl. B60K 11/02; H02K 9/22

(52) U.S. Cl. CPC B60K 11/02; H02K 9/22
USPC 165/135; 29/890.035

(57) ABSTRACT

An electromotive drive system, especially an electric wheel hub drive, for example, for an electric and/or hybrid vehicle. In order to protect heat-sensitive components of the electric motor against heat input stemming from a friction brake, the drive system includes a shielding device (1) having a coolant line (2, 2a, 2b) for cooling the shielding device (1) with a coolant. A shielding device (1), to an electric and/or hybrid vehicle as well as to a production method.

The invention relates to an electromotive drive system, to a thermal shielding device, to an electric and/or hybrid vehicle, and to a production method.

### BACKGROUND

Electric motors generally have heat-sensitive components. Thus, the rotor and the stator, especially the rotor, can react sensitively to excessive heat input.

The actuation of a friction brake, for example, can generate a great deal of heat.

A special embodiment of an electric motor is an electric wheel hub drive. A wheel hub drive comprises an electric motor that is installed directly into a wheel of a vehicle and that, at the same time, supports the wheel hub so that part of the motor rotates with the wheel. Wheel hub drives have a high integration density, which is why heat transfer from a friction brake to heat-sensitive components of the electric motor cannot be countered by increasing the distance between the friction brake and the heat-sensitive components.

### SUMMARY OF THE INVENTION

It is an object of the present invention to provide thermal shielding for heat-sensitive components of electric motors that reduces heat transfer, especially in the form of thermal radiation, to the component that is to be shielded, even in case of a large amount of heat caused, for example, by a friction brake.

The present invention provides a motor with a rotor and a stator, a friction brake and a shielding device for thermally shielding at least one component of the electric motor against heat input, especially thermal radiation, stemming from the friction brake. The shielding device comprises at least one coolant line for cooling the shielding device with a coolant.

Owing to the coolant line, the shielding device has a high heat capacity. Moreover, the coolant line makes it possible to dissipate excess heat. Thus, it is advantageous that a temperature rise and a heat transfer to the electric motor component that is to be shielded can be prevented and a particularly effective shielding of active parts of the electric motor, especially the rotor, can be achieved. In addition to shielding thermal radiation, the shielding device can also advantageously carry convection heat out of the drive system.

In particular, the drive system or the electric motor can be an electric wheel hub drive, for example, for an electric and/or hybrid vehicle. Preferably, the electric motor can be operated as a motor and as a generator.

The friction brake can especially comprise a rotating friction element and at least one brake element that can be pressed against the friction element. For example, the friction brake can be a drum brake or a disc brake. The friction element can be, for instance, a brake drum or a brake disc. Accordingly, the brake element can comprise a brake lining or brake pad or it can be a brake lining or brake pad. The brake element can be pressed against the friction element, for instance, by a brake shoe or by a brake caliper.

Water, for example, can be used as the coolant.

Within the scope of one embodiment, the shielding device has a ring-shaped body. In particular, the coolant line can be integrated into the ring-shaped body.

The term “ring-shaped body” refers to an essentially hollow-cylindrical body. In particular, the essentially hollow-cylindrical body can have an essentially round, for example, circular or ovaloid, base area. In this context, the term “essentially hollow-cylindrical” encompasses conventional hollow cylinders that have a closed circumferential surface (closed ring) as well as bodies that differ from a conventional hollow cylinder in that the circumferential surface is interrupted (open ring).

The ring-shaped body can be arranged especially at a radial distance between the friction element—for example, the brake drum or the brake disc, especially the outer circumferential surface of the brake drum or the brake disc—and the rotor, especially the inner circumferential surface of the rotor.

In particular, the body can be configured in the form of a closed ring. Owing to the design of the body in the form of a closed ring, the mechanical stability of the body can advantageously be increased.

Aside from having the ring-shaped body, the shielding device can also have at least one shielding device fastening element, especially on an end face of the ring-shaped body, for purposes of attaching the shielding device, especially to a stationary part of the drive system, especially of the electric motor. In particular, the ring-shaped body can be joined, for instance, on an end face, to the shielding device fastening element(s). In this case, the shielding device fastening element(s) can extend radially inwards, for example, on the end face.

The ring-shaped body and the shielding device fastening element(s) can be configured in one piece or in multiple pieces. All in all, the shielding device can have a pot-like structure, similar to a brake drum. Within the scope of one embodiment, the ring-shaped body and the shielding device fastening element(s) are configured in one piece, for example, in that the otherwise ring-shaped body has one or more sections on one end face that serve as shielding device fastening element(s).

The coolant line can run around the body, especially circumferentially, or it can be integrated into the body so as to run circumferentially around it.

The term “runs circumferentially around” means that the coolant line runs completely around the body in one or more coils and also that the coolant line partially runs around the body in one or more coils. For example, in a first coil, the coolant line can run around most of the circumference, optionally up to an interruption of the ring-shaped body, it can then be reversed and can once again run around most of the circumference in a second coil that runs counter to the first coil, etc.

Fundamentally, the coolant line can be configured to be partially or completely, straight, especially helical and/or meander-like. It is also possible for the coolant line to be reversed one or more times. In particular, the coolant line can have at least one meander-like section and/or at least one straight section and/or at least one reversing section.

The term “straight”, especially with reference to a straight coolant line section of a ring-shaped body, should not be construed in the strict sense of the word. Instead, a straight section of the coolant line can refer to a section that results in a ring within the scope of the production method (explained below) when a metal strip is bent with a straight (in the strict sense of the word) fluted indentation section. The resulting section, referred to as a straight section, can thus have a curvature that corresponds to the curvature of the ring-shaped body.

Within the scope of one embodiment, the coolant line alternatingly has meander-like and straight sections. Here, a reversing section can be formed between a meander-like section and a straight section. This can achieve that the coolant has a different flow direction in the meander-like sections than it does in the straight sections.

In particular, the coolant line can have a helical configuration. For example, the coolant line can be configured in the shape of a double helix or a multiple helix. The individual helix strands can be connected to each other by means of a reversing section. The helix strands as such can have a straight configuration as well as a meander-like configuration.

The coolant line can have an essentially round as well as a polygonal cross sectional surface area. In particular, the coolant line can have a circular or ovaloid, for example, elliptical or semi-circular or semi-ovoidal, for instance, semi-elliptical, cross sectional surface area.

The ring-shaped body and the coolant line can especially be formed by at least two ring-shaped metal strips that are joined to each other. Here, especially at least one of the metal strips can have a fluted indentation that forms the coolant line. Consequently, the shielding device can advantageously be produced very easily, cost-effectively and with a low weight.

Within the scope of one embodiment, only one of the metal strips has a fluted indentation that forms the coolant line, whereby the fluted indentation that forms the coolant line is covered by a second metal strip that does not have an indentation. In this manner, the coolant line can be produced very easily and with a narrow manufacturing tolerance.

Within the scope of another embodiment, two metal strips have fluted indentations, whereby the fluted indentations are configured in such a way that, when the two metal strips are laid onto each other and joined, they each form part, for example, half, of the coolant line. In this manner, the coolant flow rate can advantageously be increased and consequently, the shielding effect can be improved.

Within the scope of another embodiment, the coolant line has a coolant feed line and a coolant drain line. In particular, the coolant line can have a coolant feed line connection and a coolant drain line connection. Preferably, the coolant feed line and the coolant drain line, or the coolant feed line connection and the coolant drain line connection are arranged adjacent to each other. Preferably, the coolant feed line and the coolant drain line or the coolant feed line connection and the coolant drain line connection are laid in such a way that they come to lie close to each other along the circumference. For other configurations, however, it is likewise possible for the coolant feed line and the coolant drain line or the coolant feed line connection and the coolant drain line connection to be arranged offset. The coolant feed line and the coolant drain line or the coolant feed line connection and the coolant drain line connection can especially be connected to a cooling circuit of the drive system. In this manner, multiple benefits and a very high integration density can be achieved.

Within the scope of another embodiment, the shielding device is arranged between the friction brake and the electric motor component that is to be shielded. Preferably, the shielding device is arranged at a distance from the friction brake and/or from the electric motor component that is to be shielded.

Within the scope of another embodiment, the electric motor component that is to be shielded is the rotor and/or the stator, especially the rotor.

Within the scope of another embodiment, the friction brake is a drum brake or a disc brake. In particular, the shielding device can be arranged between the brake drum or the brake disc and the electric motor component that is to be shielded, for example, the rotor and/or the stator, especially the rotor. Here, the shielding device can especially be arranged at a distance from the brake drum or brake disc and/or from the electric motor component that is to be shielded.

For instance, the shielding device can be arranged between the brake drum and the rotor or the rotor support, especially whereby the shielding device is arranged at a distance from the brake drum as well as from the rotor or the rotor support. For example, the ring-shaped body of the shielding device can circumferentially run around the brake drum at a radial distance. The rotor or the rotor support can, in turn, circumferentially run around the ring-shaped body of the shielding device at a radial distance. A radial distance from the rotor or from the rotor support is advantageous in order not to detrimentally affect the magnetic circuit.

Within the scope of another embodiment, the shielding device is attached to a stationary component of the drive system, especially to the electric motor. In this way, the coolant line can advantageously be connected very easily to a cooling circuit of the drive system.

Another subject matter of the present invention is a shielding device for thermally shielding at least one component of an electric motor against heat input, especially thermal radiation, said shielding device comprising at least one coolant line for cooling the shielding device with a coolant. In particular, the coolant line can be integrated into the ring-shaped body.

Thanks to such a shielding device, the active parts of an electric motor, especially the rotor and/or stator, can be shielded with respect to a heat-generating structure, for example, a friction brake. In particular, the shielding device according to the invention is suitable for a drive system according to the invention. As far as additional advantages and features as well as definitions are concerned, reference is hereby made to the explanations pertaining to the drive system, to the production method and to the figures.

Within the scope of one embodiment, the body and the coolant line are made up of at least two ring-shaped metal strips that are joined to each other. Preferably, at least one of the metal strips has a fluted indentation that forms the coolant line. In this manner, the shielding device can advantageously be produced very easily, cost-effectively and with a low weight.

Within the scope of one version of this embodiment, only one of the metal strips has a fluted indentation that forms the coolant line, whereby the fluted indentation that forms the coolant line is covered by a second metal strip that does not have an indentation. In this manner, the coolant line can be produced very easily and with a narrow manufacturing tolerance.

Within the scope of another version of this embodiment, two metal strips have fluted indentations, whereby the fluted indentations are configured in such a way that, when the two metal strips are laid onto each other and joined, they each form part, for example, half, of the coolant line. In this manner, the flow rate of the coolant can advantageously be increased and consequently, the shielding effect can be improved.

Within the scope of another embodiment, the body is configured in the form of a closed ring. Owing to the design of the body in the form of a closed ring, the mechanical stability of the body can advantageously be increased.

Aside from the ring-shaped body, the shielding device can have at least one shielding device fastening element, especially on one end face of the ring-shaped body, for purposes of attaching the shielding device, especially to a stationary component of the drive system, especially of the electric motor. In particular, the ring-shaped body can be joined, for instance, on one end face, to the shielding device fastening element(s). In this case, the shielding device fastening element(s) can extend radially inwards, for example, on the end face.

The ring-shaped body and the shielding device fastening element(s) can be configured in one piece or in multiple pieces. All in all, the shielding device can have a pot-like structure, similar to a brake drum. Within the scope of one embodiment, the ring-shaped body and the shielding device fastening element(s) are configured in one piece, for example, in that the otherwise ring-shaped body has one or more sections on one end face that serve as shielding device fastening element(s).

The coolant line can run around the body, especially circumferentially.

Within the scope of another embodiment, the coolant line can be integrated into the body so as to circumferentially run around it.

Fundamentally, the coolant line can be configured to be partially or completely straight, especially helical and/or meander-like. It is also possible for the coolant line to be reversed one or more times.

Within the scope of another embodiment, the coolant line has at least one meander-like section and/or at least one straight section and/or at least one reversing section.

Within the scope of another embodiment, the coolant line alternatingly has meander-like and straight sections. In particular, a reversing section can be formed (in each case) between a meander-like section and a straight section. Meander-like sections can have a large surface area and, associated with this, good cooling properties. However, meander-like sections can increase the flow resistance. Straight sections can entail less flow resistance than meander-like sections. A combination of meander-like sections and straight sections can be particularly advantageous in this context.

Within the scope of another embodiment, the coolant line can have a helical configuration. For example, the coolant line can be configured in the shape of a double helix or a multiple helix. The individual helix strands can be connected to each other by means of a reversing section. The helix strands as such can have a straight configuration as well as a meander-like configuration.

The coolant line can have an essentially round as well as a polygonal cross sectional surface area.

Within the scope of another embodiment, the coolant line has a circular or ovaloid, for example, elliptical or semi-circular or semi-ovoidal, for example, semi-elliptical, cross sectional surface area. An ovaloid cross sectional surface area—at the same height—can have a larger cross section than a circular cross sectional surface area, as a result of which a greater quantity of coolant can be made available for heat absorption.

Moreover, the coolant line can have a coolant feed line and a coolant drain line. In particular, the coolant line can have a coolant feed line connection and a coolant drain line connection. Preferably, the coolant feed line and the coolant drain line or the coolant feed line connection and the coolant drain line connection are arranged adjacent to each other. Preferably, the coolant feed line and the coolant drain line or the coolant feed line connection and the coolant drain line connection are laid in such a way that they come to lie close to each other along the circumference. For other configurations, however, it is likewise possible for the coolant feed line and the coolant drain line or the coolant feed line connection and the coolant drain line connection to be arranged offset.

Another subject matter of the present invention is a method for the production of a shielding device according to the invention, comprising the following method steps:
a) providing a first metal strip with a fluted indentation that forms the coolant line and providing a second metal strip; and
b) joining, especially welding, the first metal strip to the second metal strip.

In this manner, the shielding device according to the invention and thus the drive system according to the invention can advantageously be produced very easily, cost-effectively and with a low weight. As far as additional advantages and features are concerned, reference is hereby made to the explanations pertaining to the drive system, to the shielding device and to the figures.

In method step a), the second metal strip can be configured without an indentation as well as with a fluted indentation that forms the coolant line.

In method step a), especially the first and the second metal strips can have the same width. In contrast, in method step a), the first and the second metal strips can have a different length. In particular, the length difference between the two metal strips can be selected here in such a way that the metal strips can be bent to form two concentric rings that are in contact with each other.

The metal strips can be made, for example, by a stamping or cutting process from a metal sheet, for instance, from a stainless steel sheet. The fluted indentations can be made in the metal, for instance, by deep-drawing, embossing or by a metal-removal process. Here, it is possible to make the fluted indentations before as well as after the metal strips are cut.

Within the scope of one embodiment, the method also comprises the following method steps:
a1) bending the first metal strip to form a ring and joining, especially welding, the two end faces of the first metal strip to each other; and
a2) bending the second metal strip to form a ring and joining, especially welding, the two end faces of the second metal strip to each other; and
a3) concentrically arranging the rings formed from the first and second metal strips.

In method step b), particularly the side edges of the rings formed from the first and second metal strips are joined, especially welded, to each other. The joining or welding can be carried out within the scope of method steps a1), a2) and/or b), especially by means of laser welding.

Another subject matter of the present invention is an electric and/or hybrid vehicle comprising a drive system according to the invention and/or a shielding device according to the invention or a shielding device produced according to the invention.

### BRIEF DESCRIPTION OF DRAWINGS

Below, the invention will be explained in greater detail with reference to the accompanying drawings. The drawings and their description serve to illustrate the subject matters according to the invention and are not to be construed to limit the invention in any manner whatsoever. The following is shown:

FIGS. 1a-c schematic views of a first embodiment of a shielding device having a meander-like coolant line with a circular cross sectional surface area;

FIGS. 2a-c schematic views of a second embodiment of a shielding device having a meander-like coolant line with an ovaloid cross sectional surface area;

FIGS. 3a-c schematic views of a third embodiment of a shielding device having a meander-like coolant line with a semi-ovaloid cross sectional surface area;

FIGS. 4a-c schematic views of a fourth embodiment of a shielding device having a helical coolant line in the form of a double helix and with a circular cross sectional surface area;

FIGS. 5a-c schematic views of a fifth embodiment of a shielding device having a coolant line with alternating meander-like and straight sections and with a circular cross sectional surface area.

### DETAILED DESCRIPTION

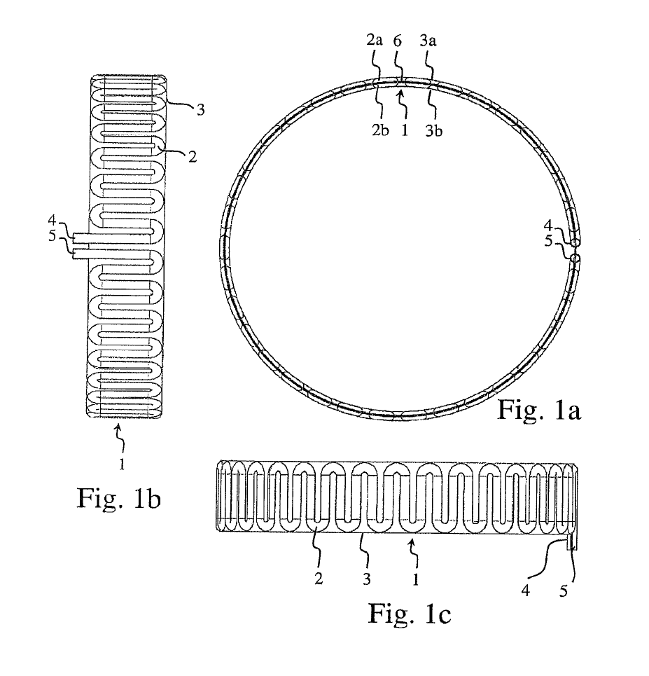

FIGS. 1a to 1c show a first embodiment of a shielding device 1 for thermally shielding at least one component of an electric motor, for example, the rotor, against heat input stemming, for example, from a friction brake. FIGS. 1a to 1c illustrate that, within the scope of this embodiment, the shielding device 1 has a ring-shaped body 3, 3a, 3b and a coolant line 2, 2a, 2b integrated into the ring-shaped body 3, 3a, 3b for cooling the shielding device 1 with a coolant. FIG. 1a illustrates that, within the scope of this embodiment, the ring-shaped body 3, 3a, 3b is an essentially hollow-cylindrical body with a closed circumferential surface (closed ring) and with a circular base area.

FIG. 1a particularly shows that the ring-shaped body 3, 3a, 3b and the coolant line 2, 2a, 2b are formed by two ring-shaped metal strips 3a, 3b that have fluted indentations 2a, 2b that form the coolant line 2, 2a, 2b, whereby their side edges are joined to each other by means of a weld seam 6. Moreover, FIG. 1a shows that the fluted indentations 2a, 2b are formed in the metal strips 3a, 3b in such a way that, when the two metal strips 3a, 3b are laid onto each other and joined, they each form part, especially half, of the coolant line 2, 2a, 2b.

FIGS. 1a to 1c also illustrate that the coolant line 2, 2a, 2b is integrated into the ring-shaped body 3, 3a, 3b so as to circumferentially run around it meander-like, and that it has a circular cross sectional surface area.

Moreover, FIGS. 1a to 1c show that the coolant line 2, 2a, 2b has a coolant feed line 4 and a coolant drain line 5, especially a coolant feed line connection 4 and a coolant drain line connection 5. Within the scope of the embodiment shown, the coolant feed line 4 and a coolant drain line 5 are arranged adjacent to each other and they are laid in such a way that they come to lie close to each other along the circumference.

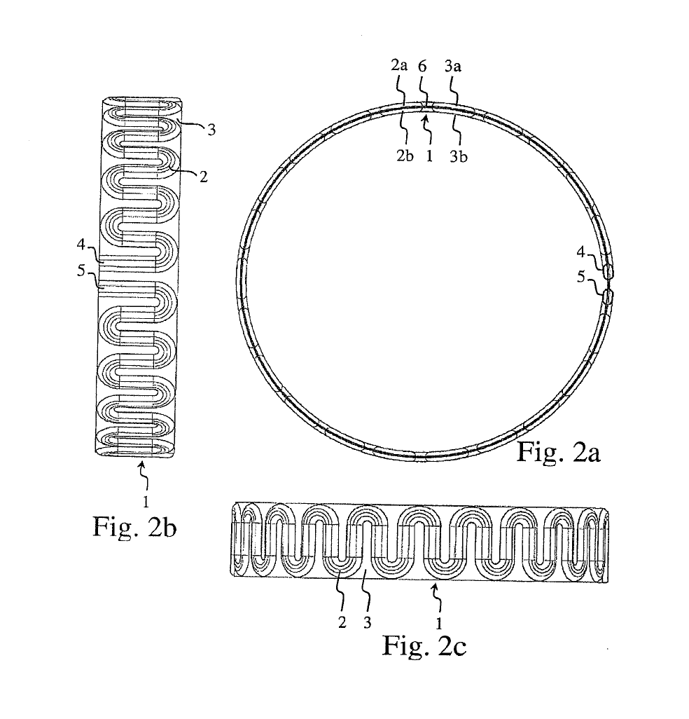

The second embodiment shown in FIGS. 2a to 2c differs from the first embodiment shown in FIGS. 1a to 1c essentially in that the coolant line 2, 2a, 2b has an ovaloid cross sectional surface area.

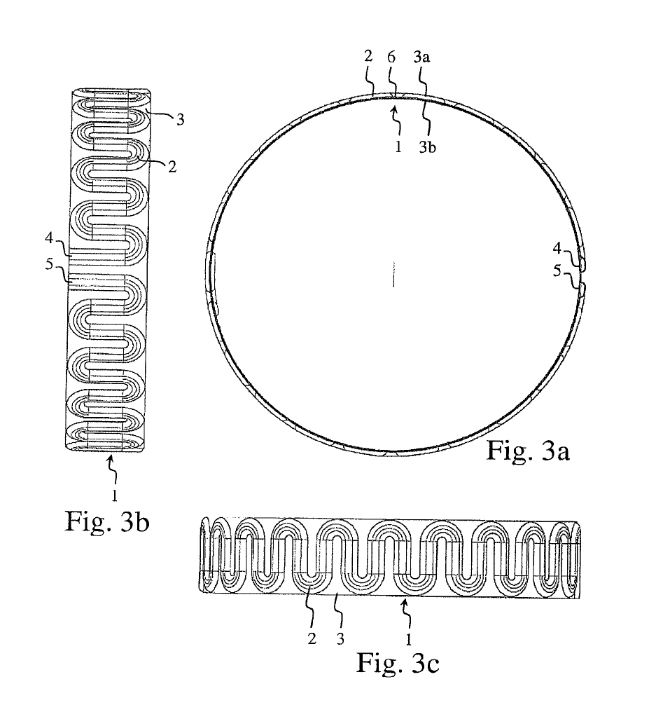

The third embodiment shown in FIGS. 3a to 3c differs from the second embodiment shown in FIGS. 2a to 2c essentially in that only one of the two metal strips 3a has a fluted indentation 2a that forms the coolant line 2, 2a, 2b, whereby the fluted indentation 2a that forms the coolant line 2, 2a, 2b is covered by a second metal strip 3b that does not have an indentation. Accordingly, the coolant line 2, 2a, 2b has only a semi-ovaloid cross sectional surface area.

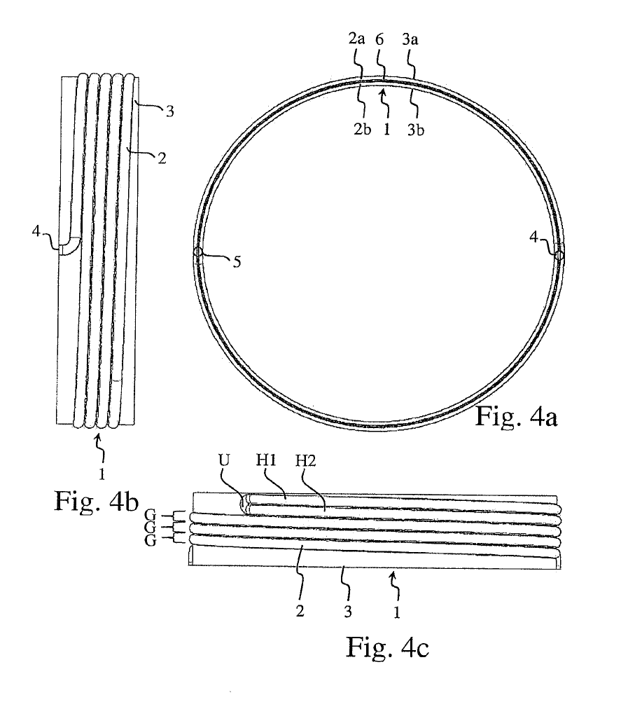

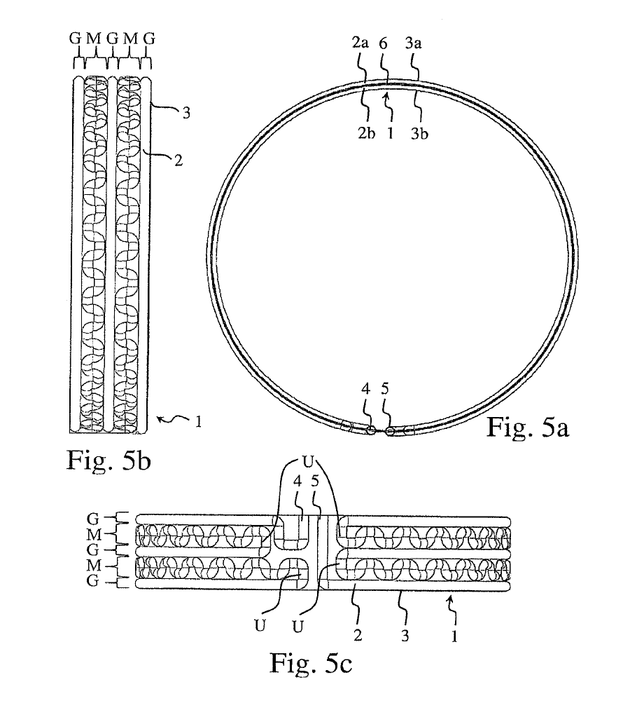

The fourth embodiment shown in FIGS. 4a to 4c differs from the first embodiment shown in FIGS. 1a to 1c essentially in that the coolant line 2, 2a, 2b has a helical configuration, and the coolant feed line 4 and the coolant drain line 5 are arranged offset relative to each other. In particular, in this embodiment, the coolant line 2, 2a, 2b is configured in the form of a double helix, whereby the individual helix strands H1, H2, which are straight as such, are joined to each other by means of a reversing section U. A uniform temperature distribution can advantageously be achieved with a coolant line 5 that is configured in this manner. FIGS. 4a to 4c—like FIGS. 5a to 5c explained below—illustrate that, in conjunction with the coolant line 2, 2a, 2b, the term “straight” should not be construed in the strict sense of the word but rather, it means that the section of the coolant line referred to as “straight” does not have any bends within the circumferential surface of the ring-shaped body 3, 3a, 3b, but all in all, can have a curvature that corresponds to the curvature of the ring-shaped body 3, 3a, 3b.

The fifth embodiment shown in FIGS. 5a to 5c differs from the first embodiment shown in FIGS. 1a to 1c essentially in that the coolant line 2, 2a, 2b alternatingly has meander-like sections M and straight sections G, whereby a reversing section U is formed between a meander-like section M and a straight section G. Moreover, within the scope of this embodiment, the coolant line 2, 2a, 2b only partially runs around the body 3, 3a, 3b. In particular, in a first coil in the form of a straight section G, the coolant line 2, 2a, 2b runs around only most of the circumference, it is then reversed in a reversing section U so that, in a second coil in the form of a meander-like section M running counter to the first coil, it once again runs around most of the circumference until, in another reversing section U, it is reversed into a third coil in the form of a straight section G running counter to the second coil, etc. A temperature distribution that is uniform over the circumference can advantageously be achieved with a coolant line 5 that is configured in this manner.

### List of Reference Numerals

1 shielding device
2 coolant line
2a fluted indentation that forms the coolant line
2b fluted indentation that forms the coolant line
3 ring-shaped body
3a first metal strip that forms the body
3b second metal strip that forms the body
4 coolant feed line
5 coolant drain line
6 weld seam of the side edges
M meander-like section of the coolant line
G straight section of the coolant line
U reversing section of the coolant line
H1 first helix strand
H2 second helix strand

What is claimed is:

1-15. (canceled)

16. A drive system for a vehicle, the drive system comprising:
an electric motor with a rotor and a stator;
a friction brake; and
a shielding device for thermally shielding at least one component of the electric motor against heat input stemming from the friction brake, the shielding device including at least one coolant line for cooling the shielding device with a coolant.

17. The drive system as recited in claim 16 wherein the shielding device has a ring-shaped body, the coolant line being integrated into the ring-shaped body.

18. The drive system as recited in claim 16 wherein the coolant line has a coolant feed line and a coolant drain line.

19. The drive system as recited in claim 18 wherein the coolant feed line and the coolant drain line are arranged adjacent to each other.

20. The drive system as recited in claim 16 wherein the shielding device is arranged between the friction brake and the component.

21. The drive system as recited in claim 20 wherein the shielding device is arranged at a distance from the friction brake and/or from the component.

22. The drive system as recited in claim 16 wherein the friction brake is a drum brake or a disc brake.

23. The drive system as recited in claim 16 wherein the at least one component is the rotor and/or the stator.

24. The drive system as recited in claim 16 wherein the at least one component is the rotor.

25. The drive system as recited in claim 16 wherein the shielding device is attached to a stationary component of the drive system.

26. The drive system as recited in claim 25 wherein the stationary component is the electric motor.

27. An electromotive drive system for an electric and/or hybrid vehicle comprising the drive system as recited in claim 16.

28. A shielding device for thermally shielding at least one component of an electric motor against heat input, the shielding device comprising:
a ring-shaped body; and
at least one coolant line for cooling the shielding device with a coolant.

29. The shielding device as recited in claim 28 wherein the coolant line is integrated into the ring-shaped body.

30. The shielding device as recited in claim 28 wherein the body and the coolant line are formed by at least two ring-shaped metal strips joined to each other.

31. The shielding device as recited in claim 30 wherein at least one of the metal strips has a fluted indentation forming the coolant line.

32. The shielding device as recited in claim 28 wherein the body is configured in the form of a closed ring.

33. The shielding device as recited in claim 28 wherein the coolant line is integrated into the body so as to circumferentially run around the body, and/or the coolant line has at least one meander section and/or at least one straight section and/or at least one reversing section.

34. The shielding device as recited in claim 33 wherein the coolant line alternatingly has the meander and straight sections, and having a helical configuration.

35. A method for the production of a shielding device as recited in claim 16, comprising the following method steps:
a) providing a first metal strip with a fluted indentation forms the coolant line and providing a second metal strip, whereby the first and the second metal strips have the same width and a different length, whereby the length difference between the two metal strips is selected in such a way that the metal strips can be bent to form two concentric rings that are in contact with each other; and
b) joining the first metal strip to the second metal strip.

36. The method as recited in claim 35 further comprising the following method steps:
a1) bending the first metal strip to form a ring and joining the two end faces of the first metal strip to each other; and
a2) bending the second metal strip to form a ring and joining the two end faces of the second metal strip to each other; and
a3) concentrically arranging the rings formed from the first and second metal strips;
whereby in method step b), the side edges of the rings formed from the first and second metal strips are joined to each other.

37. An electric and/or hybrid vehicle, comprising the drive system as recited in claim 16.

38. An electric and/or hybrid vehicle, comprising the drive system as recited in claim 28.
